(19) United States
(12) Patent Application Publication
(10) Pub. No.: US 2004/0220041 A1
(43) Pub. Date: Nov. 4, 2004

(54) Optical glass

(75) Inventors: Jyunichi Isowaki, Yotsukaido-shi (JP); Akihiro Takishita, Yotsukaido-shi (JP)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: HIKARI GLASS CO., LTD.

(21) Appl. No.: 10/851,152

(22) Filed: May 24, 2004

(30) Foreign Application Priority Data
Nov. 28, 2002 (JP) 2003-346177

(51) Int. Cl. C03C 3/068

(52) U.S. Cl. 501/78

(57) ABSTRACT

There is provided an optical glass that (1) has a high refractive index and high dispersion, (2) does not include any Pb compound that will tend to adversely impact the environment or human bodies, (3) is excellent in terms of economic efficiency, and (4) is suitable for mass production. This optical glass contains SiO₂, B₂O₃, BaO, La₂O₃, TiO₂, and, as necessary, one or more from Nb₂O₅, Ta₂O₅, WO₃, ZrO₂, MgO, CaO, SrO, ZnO, Li₂O, Na₂O, K₂O, Y₂O₃, Gd₂O₃, and Al₂O₃—each in an amount within a predetermined range. This optical glass also has optical constant values such as a refractive index (nd) of 1.70-1.93 and an Abbe number (vd) of 28-45.

### BACKGROUND OF THE INVENTION

This invention relates to an optical glass, and more particularly to a high-refractive-index and high-dispersion optical glass.

Various types of high-refractive-index and high-dispersion optical glass containing lead compounds have been well-known and have been commercially manufactured. However, they have the problem that most of the glasses contain toxic lead in their composition.

High-refractive-index and high-dispersion glass compositions that are lead-free have been proposed, but most of them have not been satisfactory in terms of economic efficiency or suitability for mass production.

Japanese Unexamined Published Patent Application No. S58-69739 discloses a B₂O₃—SiO₂—La₂O₃—ZrO₂—(Nb₂O₅/Ta₂O₅)-based optical glass. The glass of this composition, however, is inferior in its meltability and devitrification resistance, because the composition contains a large amount of La₂O₃ instead of BaO. It also is unsatisfactory in terms of cost efficiency, because it includes expensive Nb₂O₅ and Ta₂O₅, which together account for 14% or more of the total weight of the composition.

Japanese Unexamined Published Patent Application No. S58-125637 discloses an SiO₂—B₂O₃—CaO—La₂O₃—ZrO₂—TiO₂—Nb₂O₅-alkaline metal-oxides-based optical glass. The glass of this composition, however, is poor in chemical durability, is volatile in a molten condition because alkaline metal oxides account for more than 2% of its weight, and is inferior in devitrification resistance and moldability because in a molten condition its viscosity is too low.

Japanese Unexamined Published Patent Application No. S59-50048 discloses an SiO₂—B₂O₃—La₂O₃—Nb₂O₅—ZrO₂—TiO₂-alkaline earth-metals-based optical glass. When the glass of this composition is in a molten condition, sometimes portions of it remain unmolten because it contains a larger amount of SiO₂ than of B₂O₃. Another shortcoming is that it requires the addition of expensive Nb₂O₅ in order to secure devitrification resistance.

Japanese Unexamined Published Patent Application No. S62-100449 discloses a B₂O₃—La₂O₃—ZnO—Li₂O—Sb₂O₃-based optical glass. The glass of this composition easily becomes stained to an umber color due to its strong reductivity, which results because it contains too much Sb₂O₃, which ranges from 2% to 20% of the total weight of the composition (hereinafter “wt. %”).

Japanese Unexamined Published Patent Application No. H07-41334 discloses an SiO₂—B₂O₃—La₂O₃—TiO₂—CaO-based optical glass. The glass of this composition also easily becomes stained, due to its high content of TiO₂, which ranges from 19 wt % to 31 wt % in order to raise the refractive index.

Japanese Unexamined Published Patent Application No. 2001-72432 discloses a SiO₂—B₂O₃—La₂O₃—TiO₂—CaO—BaO-based optical glass. The meltability of this composition is not very good, and it has difficulty in securing both a high refractive index and devitrification resistance.

The glass of this composition is not good in meltability and difficult in securing both a high refractive index and devitrification by the reason of containing as high as 7 to 40% of CaO.

Under these circumstances, there is a strong need for optical glass that has a high refractive index and high dispersion, and that does not contain toxic lead.

### SUMMARY OF THE INVENTION

The primary objectives of the present invention are to provide optical glass that has a high refractive index and high dispersion, that does not contain lead in its composition, and that maintains economic efficiency that makes mass-production feasible.

These objectives are attained by providing optical glass that includes: (a) SiO₂ in an amount ranging from 1 wt % to 10 wt %; (b) B₂O₃ in an amount ranging from 10 wt % to 35 wt %; (c) BaO in an amount ranging from 13 wt % to 30 wt %; (d) La₂O₃ in an amount ranging from 10 wt % to 40 wt %; and (e) TiO₂ in an amount ranging from 5 wt % to 15 wt %.

Optical glass of this invention can further contain one or more compositions of the following components: Nb₂O₅, Ta₂O₅, WO₃, ZrO₂, MgO, CaO, SrO, ZnO, Li₂O, Na₂O, K₂O, Y₂O₃, Gd₂O₃, and Al₂O₃, wherein Nb₂O₅ is in an amount less than 20 wt %, Ta₂O₅ is in an amount less than 10 wt %, WO₃ is in an amount less than 10 wt %, ZrO₂ is in an amount less than 10 wt %, MgO is in an amount less than 10 wt %, CaO is in an amount less than 7 wt %, SrO is in an amount less than 10 wt %, ZnO is in an amount less than 20 wt %, the sum of Li₂O, Na₂O and K₂O is in an amount less than 2 wt %, Y₂O₃ is in an amount less than 15 wt %, Gd₂O₃ is in an amount less than 15 wt %, Yb₂O₃ is in an amount less than 10 wt %, and Al₂O₃ is in an amount less than 5 wt %.

It is preferable that optical glass of this invention have a refractive index (nd) of 1.70-1.93 and an Abbe number (vd) of 28-45.

### DESCRIPTION OF THE PREFERRED EMBODIMENTS

Optical glass according to the present invention includes specific components as described above. Each of these components has different functions in optical glass. The specific combination of these components can bring about preferred properties, such as a high refractive index of 1.70-1.93 and a high-dispersion Abbe number of 28-45, which are suitable for optical glass without lead being added. Thus, the ratios of these components are determined based attaining on a subtle balance among the individual components used. In other words, satisfactory optical glass can be obtained only when all of the components that are used are well-balanced within the specific ranges prescribed for the preferred embodiments of this invention.

SiO₂ is a network-forming oxide. For the preferred embodiments of this invention, the level of SiO₂ in optical glass will be 1 wt %-10 wt %. A content of less than 1 wt % will tend to easily devitrify the glass and make it difficult to mold the glass, due to the low viscosity of the composition in a molten condition. A content in excess of 10 wt % will tend to lower the refractive index of the glass and leave some portions of the composition unmolten when it is melted.

B₂O₃ also is a network-forming oxide. For the preferred embodiments of this invention, the level of B₂O₃ will be 10 wt %-35 wt %. A content of less than 10 wt % will tend to deteriorate both the devitrification and the moldability of the glass. In contrast, a content in excess of 35 wt % will tend to make it difficult for the glass to have a high refractive index and will tend to lower the moldability of the glass, due to the low viscosity of the glass in a molten condition.

BaO increases the refractive index of the glass without staining the glass, and it represses the devitrification that can occur in the glass. For the preferred embodiments of this invention, BaO will be 13 wt %-30 wt % of the optical glass in order to obtain a high refractive index. A content of less than 13 wt % will tend to be too little for the BaO to be effective, and a content in excess of 30 wt % will tend to lower the chemical durability of the glass.

La₂O₃ increases the refractive index without staining the glass, and it improves the chemical durability of the glass. For the preferred embodiments of this invention, the level of La₂O₃ in the optical glass will be 10 wt %-40 wt %, in order to obtain optical glass having a high refractive index. A content of less than 10 wt % will tend to be too little for the La₂O₃ to be effective, and a content in excess of 40 wt % will tend to deteriorate the meltability of the glass and cause it to easily become devitrified.

TiO₂ increases both the refractive index and the dispersion of the glass. For the preferred embodiments of this invention, TiO₂ will be 5 wt %-15 wt % of the optical glass. A content of less than 5 wt % will tend to be too little for the TiO₂ to be effective, and a content in excess of 15 wt % will cause the optical glass to stain easily.

Optical glass of this invention can optionally contain, in addition to the above-mentioned components, one or more of the following components: Nb₂O₅, Ta₂O₅, WO₃, ZrO₂, MgO, CaO, SrO, ZnO, Li₂O, Na₂O, K₂O, Y₂O₃, Gd₂O₃, Yb₂O₃, and Al₂O₃—in an amount specified for each component.

Nb₂O₅ increases both the refractive index and the dispersion of the glass, and it improves the glass's devitrification resistance. For the preferred embodiments of this invention, Nb₂O₅ will be less than 20 wt % of the optical glass. A content in excess of 20 wt % will lower the devitrification resistance of the glass and will stain the glass. However, because Nb₂O₅ is expensive, its content is preferably less than 5 wt % in view of the need for economic efficiency. An Nb₂O₅ content of less than 5 wt % also reduces tendency of Nb₂O₅ to stain the glass.

Ta₂O₅ increases the refractive index and improve the chemical durability of the glass. For the preferred embodiments of this invention, Ta₂O₅ will be less than 10 wt % of the optical glass. A content in excess of 10 wt % will tend to deteriorate the devitrification resistance. However, because Ta₂O₅ is expensive, its content is preferably less than 2 wt %.

WO₃ increases both the refractive index and the dispersion of the glass and improves its devitrification resistance. For the preferred embodiments of this invention, WO₃ will be less than 10 wt %. A content in excess of 10 wt % will tend to stain the glass.

ZrO₂ increases the refractive index and the dispersion of the glass without staining the glass, and for the preferred embodiments of this invention, it will be limited to less than 10 wt % of the optical glass. A content in excess of 10 wt % will tend to reduce the meltability of the glass and will tend to lower the glass's devitrification resistance.

MgO is useful for adjusting the optical properties of the glass, and for the preferred embodiments of this invention, it will be limited to less than 10 wt % of the optical glass. A content in excess of 10 wt % will deteriorate the meltability of the glass.

CaO lowers the specific gravity of the glass, improves the chemical durability of the glass, and for the preferred embodiments of this invention, it will be limited to less than 7 wt % of the optical glass. A content in excess of 7 wt % will tend to reduce the meltability of the glass and will tend to lower the glass's devitrification resistance.

SrO is useful for adjusting the optical properties of the glass, and for the preferred embodiments of this invention, it will be limited to less than 10 wt % of the optical glass. A content in excess of 10 wt % will tend to lower the glass's devitrification resistance.

ZnO improves the meltability of the glass and lowers its press-molding temperature so as to prevent degradation of a press mold. For the preferred embodiments of this invention, ZnO will be less than 20 wt % of the optical glass. A content in excess of 20 wt % will tend to lower the glass's devitrification resistance.

Any of Li₂O, Na₂O, or K₂O improves the meltability of the glass and lowers its press-molding temperature so as to prevent the degradation of a press mold. For the preferred embodiments of this invention, the sum of Li₂O, Na₂O, and K₂O will be less than 2 wt % of the optical glass. If their combined content is in excess of 2 wt % total of the optical glass, they will tend to lower its devitrification resistance, and will tend to make press-molding difficult by increasing the volatility and lowering the viscosity of the glass in a molten condition.

Any of Y₂O₃, Gd₂O₃, or Yb₂O₃ improves the chemical durability of the glass and increases its refractive index without staining the glass. For the preferred embodiments of this invention, Y₂O₃ will be less than 15 wt %, Gd₂O₃ will be less than 15 wt %, and Yb₂O₃ will be less than 10 wt % of the optical glass. A content in excess of any of those limits will tend to lower the glass's devitrification resistance.

Any of Y₂O₃, Gd₂O₃, or Yb₂O₃ is preferably replaced with La₂O₃, because in terms of functioning La₂O₃ acts nearly the same as each of them does.

Al₂O₃ increases the chemical durability of the glass, and for the preferred embodiments of this invention it will be less than 5 wt % of the optical glass. A content in excess of 5 wt % will tend to make it difficult for the glass to have a high refractive index and will tend to leave some portions of the composition unmolten when the glass is melted.

As mentioned above, optical glass according to the present invention includes SiO₂, B₂O₃, BaO, La₂O₃, and TiO₂ as essential components. In addition, the glass can optionally include one or more components from Nb₂O₅, Ta₂O₅, WO₃, ZrO₂, MgO, CaO, SrO, ZnO, Li₂O, Na₂O, K₂O, Y₂O₃, Gd₂O₃, and Al₂O₃.

Other than above, Sb₂O₃, As₂O₃ or another component also can be added as a defoamer, which is usually 1 wt % or less of optical glass. Refining agents, colorants, fluorides P₂O₅ also can be added to an optical glass composition. This invention does not limit the use of those supplemental components insofar as they do not have any adverse effect on this invention.

Optical glass according to this invention can be manufactured by any suitable method and manner known in the art. Typically, raw materials such as oxides, carbonates, and nitrates are blended to make the prescribed composition, which is then heated at 1100° C.-1400° C. so as to make it molten; the composition is then agitated so as to make it uniform, after which it is defoamed and then poured into a metallic die.

### EXAMPLES

The present invention will be discussed in further detail in the presentations of the following examples, but the present invention is not limited to these examples.

Glass raw materials such as oxides, carbonates and nitrates were blended into the compositions shown in Table 1 and 2, mixed well, then put into a platinum pot and kept in an electrically heated furnace at 1200° C. to 1400° C. for 1 hour to 2 hours while being C with agitated. The mixture, after being clarified, was put into a pre-heated iron mold and cooled so as to give optical glass. The refractive index (nd) at the helium d-line and the Abbe number (vd) were measured by methods well-known to those in the art. Data regarding the refractive index and the Abbe number also are shown in Tables 1 and 2.

TABLE 1
Examples of Glass Compositions and Properties Thereof (Nos. 1-8)

| | Examples of Glass Compositions | | | | | | | |
|---|---|---|---|---|---|---|---|---|
| | (wt % of each component) | | | | | | | |
| Components | Examples→ | | | | | | | |
| [symbol] | No. 1 | No. 2 | No. 3 | No. 4 | No. 5 | No. 6 | No. 7 | No. 8 |
| SiO₂ | 8.7 | 8.8 | 7.5 | 1.8 | 9.9 | 9.9 | 7.8 | 7.3 |
| B₂O₃ | 17.4 | 10.5 | 21.3 | 29.7 | 10.6 | 34.9 | 15.5 | 15.8 |
| BaO | 29.5 | 25.9 | 25.5 | 13.7 | 29.5 | 29.5 | 13.3 | 13.1 |
| La₂O₃ | 30.3 | 39.9 | 39.8 | 39.9 | 35.1 | 10.8 | 29.0 | 11.1 |
| TiO₂ | 14.1 | 14.9 | 5.9 | 14.9 | 14.9 | 14.9 | 13.0 | 12.8 |
| Nb₂O₅ | | | | | | | 10.3 | 8.5 |
| Ta₂O₅ | | | | | | | | |
| WO₃ | | | | | | | | 2.9 |
| ZrO₂ | | | | | | | 8.2 | 3.0 |
| MgO | | | | | | | | |
| CaO | | | | | | | | 6.8 |
| SrO | | | | | | | | |
| ZnO | | | | | | | 4.8 | 4.5 |
| Li₂O | | | | | | | 1.0 | |
| Na₂O | | | | | | | 0.5 | |
| K₂O | | | | | | | 0.3 | |
| Y₂O₃ | | | | | | | | 13.7 |
| Gd₂O₃ | | | | | | | | |
| Yb₂O₃ | | | | | | | | |
| Al₂O₃ | | | | | | | 1.1 | 0.5 |
| Properties | | | | | | | | |
| nd | 1.82 | 1.87 | 1.77 | 1.82 | 1.86 | 1.72 | 1.88 | 1.86 |
| νd | 34.5 | 32.5 | 43.3 | 37.7 | 32.9 | 35.4 | 29.8 | 30.2 |

TABLE 2
Examples of Glass Compositions and Properties Thereof (Nos. 9-16)

| | Examples of Glass Compositions | | | | | | | |
|---|---|---|---|---|---|---|---|---|
| | (wt % of each component) | | | | | | | |
| Components | Examples→ | | | | | | | |
| [symbol] | No. 9 | No. 10 | No. 11 | No. 12 | No. 13 | No. 14 | No. 15 | No. 16 |
| SiO₂ | 4.7 | 8.0 | 9.9 | 9.9 | 6.6 | 7.8 | 7.8 | 7.8 |
| B₂O₃ | 16.2 | 15.6 | 19.1 | 15.6 | 12.0 | 15.6 | 15.6 | 14.6 |
| BaO | 16.7 | 22.0 | 23.2 | 13.3 | 15.5 | 15.7 | 13.1 | 13.3 |
| La₂O₃ | 19.0 | 21.3 | 22.2 | 16.3 | 34.5 | 26.6 | 16.3 | 16.7 |
| TiO₂ | 12.5 | 13.1 | 8.9 | 14.8 | 10.0 | 12.9 | 14.8 | 12.0 |
| Nb₂O₅ | 3.0 | | | | 19.9 | | | 3.0 |
| Ta₂O₅ | | | 8.8 | 3.3 | | | 1.5 | |
| WO₃ | | 4.5 | 7.6 | | | | 7.8 | 2.9 |
| ZrO₂ | | | | | | | | 8.2 |
| MgO | | | | 9.3 | | | 9.2 | |
| CaO | | 2.0 | | 0.8 | | | | 6.8 |
| SrO | | | | 8.8 | | | 8.8 | |
| ZnO | 8.4 | 3.9 | | 2.1 | | 19.9 | | |
| Li₂O | | 0.5 | | | | | 1.0 | |
| Na₂O | | | | | 0.5 | 0.5 | | 0.5 |
| K₂O | | | 0.3 | | 1.0 | 1.0 | 0.5 | 0.5 |
| Y₂O₃ | | 5.0 | | 3.5 | | | | 13.7 |
| Gd₂O₃ | 12.3 | | | 2.3 | | | 3.6 | |
| Yb₂O₃ | 7.2 | | | | | | | |
| Al₂O₃ | | 4.1 | | | | | | |
| Properties | | | | | | | | |
| nd | 1.86 | 1.80 | 1.80 | 1.81 | 1.92 | 1.83 | 1.81 | 1.84 |
| νd | 32.7 | 34.1 | 34.5 | 33.2 | 32.0 | 33.9 | 33.4 | 33.3 |

1. An optical glass, comprising:
(a) SiO₂ in an amount ranging from 1 wt % to 10 wt %;
(b) B₂O₃ in an amount ranging from 10 wt % to 35 wt %;
(c) BaO in an amount ranging from 13 wt % to 30 wt %;
(d) La₂O₃ in an amount ranging from 10 wt % to 40 wt %; and
(e) TiO₂ in an amount ranging from 5 wt % to 15 wt %.

2-3. (Cancelled).

4. The optical glass of claim 1, further comprising one or more of Nb₂O₅, Ta₂O₅, WO₃, ZrO₂, MgO, CaO, SrO, ZnO, Li₂O, Na₂O, K₂O, Y₂O₃, Gd₂O₃ or Al₂O₃, wherein Nb₂O₅ is in an amount less than 20 wt %, Ta₂O₅ is in an amount less than 10 wt %, WO₃ is in an amount less than 10 wt %, ZrO₂ is in an amount less than 10 wt %, MgO is in an amount less than 10 wt %, CaO is in an amount less than 7 wt %, SrO is in an amount less than 10 wt %, ZuO is in an amount less than 20 wt %, the sum of Li₂O, Na₂O and K₂O is in an amount less than 2 wt %, Y₂O₃ is in an amount less than 15 wt %, Gd₂O₃ is in an amount less than 15 wt %, Yb₂O₃ is in an amount less than 10 wt % and Al₂O₃ is in an amount less than 5 wt %.

5. The optical glass of claim 1, wherein the refractive index (nd) of said optical glass is 1.70-1.93 and the Abbe number (vd) is 28-45.

6. The optical glass of claim 5, wherein said Abbe number (vd) is 32.5-43.4.

7. The optical glass of claim 5, having a refractive index (nd) of 1.72-1.87.

8. The optical glass of claim 1, which does not contain any lead.

9. The optical glass of claim 1, further comprising refining agents, colorants, fluorides or P₂O₅.
